(19) United States
(12) Patent Application Publication
(10) Pub. No.: US 2023/0275687 A1
(43) Pub. Date: Aug. 31, 2023

(54) CHANNEL CODING METHOD AND COMMUNICATION APPARATUS

(71) Applicant: HUAWEI TECHNOLOGIES CO., LTD., Shenzhen (CN)

(72) Inventors: Jiahui LI, Shenzhen (CN); Mengyao MA, Shenzhen (CN); Wei LIN, Shenzhen (CN); Yan CHEN, Ottawa (CA); Xun YANG, Shenzhen (CN)

(21) Appl. No.: 18/142,673

(22) Filed: May 3, 2023

Related U.S. Application Data
(63) Continuation of application No. PCT/CN2021/128296, filed on Nov. 3, 2021.

(30) Foreign Application Priority Data
Nov. 5, 2020 (CN) 202011225790.5

(51) Int. Cl. H04L 1/00

(52) U.S. Cl. CPC H04L 1/0013; H04L 1/0036

(57) ABSTRACT

This application provides a coding method and a communication apparatus, which may be applied to wireless data transmission. The method includes: A sending apparatus sends indication information to a receiving apparatus, where the indication information indicates first information and second information. The first information indicates a coding scheme of to-be-encoded data, and the coding scheme includes a coding matrix for channel coding and a channel coding mode. The second information indicates a distribution feature of the to-be-encoded data. The sending apparatus performs channel coding on the to-be-encoded data based on the coding scheme, to obtain encoded data. The receiving apparatus receives the indication information sent by the sending apparatus, and the receiving apparatus performs channel decoding on received data based on the indication information, to obtain decoded data.

### CROSS-REFERENCE TO RELATED APPLICATIONS

This application is a continuation of International Application No. PCT/CN2021/128296, filed on Nov. 3, 2021, which claims priority to Chinese Patent Application No. 202011225790.5, filed on Nov. 5, 2020. The disclosures of the aforementioned applications are hereby incorporated by reference in their entireties.

### TECHNICAL FIELD

This application relates to the field of communication technologies, and in particular, to a channel coding method and a communication apparatus.

### BACKGROUND

As information technologies develop and the society progresses, human beings have higher requirements for integrated services such as voice, data, an image, and video and communication services such as different types of multimedia services. A wireless communication technology is developed fast because of its advantages such as no need to establish a physical line, low costs, and a strong ability to resist an environmental change. Therefore, a wireless data coding and transmission technology becomes a current research hotspot in the communication field. In wireless communication transmission, wireless data needs to be compressed efficiently due to a limited bandwidth of a wireless channel. However, when technologies such as predictive coding and variable-length coding used in conventional source compression achieve efficient compression, even a channel bit error of a single bit may cause a decompression error or failure of an entire segment of data source. It is well known that there are various types of noise interference in the wireless channel, which results in a high bit error rate. Therefore, how to transmit high-quality data on a wireless mobile network is a highly challenging task.

### SUMMARY

Embodiments of this application provide a coding method and a related apparatus. A sending apparatus may use a coding scheme, to reduce interference and decrease a bit error rate. The following describes this application from different aspects. It should be understood that, for implementations and beneficial effects of the following different aspects, refer to each other.

According to a first aspect, this application provides a coding method, where the method includes:

sending indication information, where the indication information indicates first information or second information, or the indication information indicates first information and second information;

the first information indicates a coding scheme of to-be-encoded data, and the coding scheme includes a coding matrix for channel coding and/or a channel coding mode; and the second information indicates a distribution feature of the to-be-encoded data; and

performing channel coding on the to-be-encoded data based on the coding scheme, to obtain encoded data.

According to a second aspect, this application further provides a coding method, where the method includes:

receiving indication information, where the indication information indicates first information or second information, or the indication information indicates first information and second information;

the first information indicates a coding scheme of to-be-encoded data, and the coding scheme includes a coding matrix for channel coding and/or a channel coding mode; and the second information indicates a distribution feature of the to-be-encoded data; and

performing channel decoding on received data based on the indication information, to obtain decoded data.

According to a third aspect, this application provides a communication apparatus (which may also be referred to as a sending apparatus), including:

a sending unit, configured to send indication information, where the indication information indicates first information or second information, or the indication information indicates first information and second information, where

the first information indicates a coding scheme of to-be-encoded data, and the coding scheme includes a coding matrix for channel coding and/or a channel coding mode; and the second information indicates a distribution feature of the to-be-encoded data; and

a processing unit, configured to perform channel coding on the to-be-encoded data based on the coding scheme, to obtain encoded data.

According to a fourth aspect, this application further provides a communication apparatus (which may also be referred to as a receiving apparatus), including:

a receiving unit, configured to receive indication information, where the indication information indicates first information or second information, or the indication information indicates first information and second information, where

the first information indicates a coding scheme of to-be-encoded data, and the coding scheme includes a coding matrix for channel coding and/or a channel coding mode; and the second information indicates a distribution feature of the to-be-encoded data; and

a processing unit, configured to perform channel decoding on received data based on the received indication information, to obtain decoded data.

In an embodiment, the first information indicates the coding scheme of the to-be-encoded data, and the to-be-encoded data includes original data or data obtained after source coding is performed on the original data. The coding scheme includes the coding matrix for channel coding and the channel coding mode. The coding matrix is used to encode the to-be-encoded data (or a to-be-transmitted information bit), which may be indicated by using uplink control information, downlink control information, or the like at a physical layer. The channel coding mode indicates a puncturing manner of encoded information bits, or the channel coding mode indicates a puncturing manner of a part of the encoded information bits and a data length of the part of the encoded information bits. The channel coding mode is carried in control information of a MAC layer.

In an embodiment, the channel coding mode includes a first channel coding mode, a second channel coding mode, and a third channel coding mode. The first channel coding mode indicates a sending apparatus not to puncture the encoded information bits, to provide higher transmission reliability when a channel state is poor. The second channel coding mode indicates the sending apparatus to puncture all the encoded information bits, to implement a higher source compression rate when the channel state is good, thereby saving transmission resources for transmitting more source information. The third channel coding mode indicates the sending apparatus to puncture the part of the encoded information bits, which can dynamically adapt to different channel states and support more flexible adjustment of a source compression rate. According to transmission of different source distribution, different channel coding modes can flexibly adjust an actual code rate.

In an embodiment, the second information indicates the distribution feature (or referred to as source distribution information) of the to-be-encoded data, and is carried in the control information of the MAC layer. The distribution feature or the source distribution information of the to-be-encoded data is determined based on a distribution probability of the to-be-encoded data or an information entropy of the to-be-encoded data. When source distribution is different, corresponding source entropies are different, in other words, source compressible redundancy changes. Therefore, different compression rates need to be used to compress a source (the to-be-encoded data), and the source distribution information indicates transmission that can be performed based on the different source distribution, to flexibly adjust the actual code rate. In addition, when the channel coding matrix is designed, the source distribution may also be used as additional information, to improve coding performance. The receiving apparatus can use the source distribution information to improve decoding performance.

In an embodiment, the channel coding mode indicated by the first information is determined based on the distribution probability of the to-be-encoded data or the information entropy of the to-be-encoded data, channel state information, and a quantity of currently allocated available resources of a channel.

In an embodiment, the indication information indicates information in an independent indication manner, and the independent indication manner can independently (separately) indicate the coding scheme and the source distribution information of the to-be-encoded data. The coding scheme of the to-be-encoded data includes the coding matrix for channel coding and/or the channel coding mode. The channel coding mode of the to-be-encoded data is used as an example. The information indication is performed by separately carrying the channel coding mode or the source distribution information of the to-be-encoded data. This implementation is more flexible. In some cases, if there are two pieces of information to be sent, one piece of information may be sent independently, and the other piece of information may continue to use indication information at a previous moment or a default value agreed upon in advance by both the sender and the receiver.

In another embodiment, the indication information indicates information in a joint indication manner, and the joint indication manner can jointly indicate the coding scheme and the source distribution information of the to-be-encoded data. The coding scheme of the to-be-encoded data includes the coding matrix for channel coding and/or the channel coding mode. The channel coding mode of the to-be-encoded data is used as an example, the information indication is performed by carrying both the channel coding mode and the source distribution information of the to-be-encoded data in the joint indication manner. In this implementation, signaling overheads can be reduced when both the channel coding mode and the source distribution need to be indicated.

In an embodiment, the independent indication manner or the joint indication manner may be performed in different indication forms. For example, three different indication forms may be included. A first indication form is applied to downlink data transmission, and may be referred to as a downlink indication manner. A base station (the sending apparatus) sends indication information to user equipment (a terminal), for example, carrying the indication information in a MAC CE field, and then the base station performs channel coding based on the indication information, to determine a data block and a check bit that are to be sent to the user equipment and complete subsequent downlink data transmission. A second indication form is applied to uplink data transmission, and uplink user equipment UE may actively send an indication. For example, the user equipment sends, to a base station, a MAC CE field that carries indication information, and the user equipment performs channel coding based on the indication information, to determine a data block and a check bit that are to be sent to the base station and complete subsequent uplink data transmission. A third indication manner is used for uplink data transmission. An uplink base station requests user equipment to report an indication. The base station sends a report request to the user equipment. The report request indicates the user equipment to report indication information to the base station. The user equipment sends, to the base station, a MAC CE field that carries the indication information. Then, the user equipment performs channel coding based on the indication information reported by the user equipment, to determine a data block and a check bit that are to be sent and complete subsequent uplink data transmission.

The information indication manner may also be classified into a semi-static mode and a dynamic mode. In an embodiment, the semi-static mode may be applied to an indication of the coding scheme, in other words, corresponding indication information may be sent to modify a current coding scheme for data transmission. In another embodiment, the dynamic mode may be applied to the independent indication manner or may be applied to the joint indication manner. In the dynamic mode, corresponding indication information may be separately sent to indicate a coding scheme or source distribution used for a specific data part, or corresponding indication information may be simultaneously sent to indicate a channel coding scheme and source distribution used for a specific data part. In the semi-static signaling indication manner, signaling overheads can be reduced without frequently switching the channel coding mode. In the dynamic indication manner, different information may be separately indicated, and a more flexible information configuration manner is provided.

In an embodiment, in the dynamic mode, corresponding indication information may be sent to indicate a coding scheme used for a specific data part, and the specific data part is a data part on which the indication information is applied. When the specified data part is exceeded or after one dynamic mode indication ends, data transmission automatically changes back to a default mode.

In an embodiment, in the dynamic mode, corresponding indication information may be sent to indicate source distribution information of a specific data part, and the specific data part is a data part to which the indication information is applied. When the specified data is exceeded or after one dynamic mode indication ends, data source distribution information is a default source probability density.

In an embodiment, in the dynamic mode, corresponding indication information may be sent to indicate a coding scheme and source distribution information used for a specific data part, and the specific data part means a data field on which the indication information is applied. When the specified data part is exceeded or after one dynamic mode indication ends, data transmission automatically changes back to a default mode.

According to a fifth aspect, a communication apparatus is provided, applied to a sending apparatus, and including a processor. The processor is configured to execute computer instructions, to implement any method provided in the first aspect, and may be the communication apparatus according to the third aspect.

In an embodiment, the communication apparatus further includes a memory, the processor is coupled to the memory, and the memory is configured to store the computer instructions.

In an embodiment, the memory and the processor are integrated together, or the memory and the processor are independent components.

In an embodiment, the sending apparatus further includes a communication interface and a communication bus, and the processor, the memory, and the communication interface are connected through the communication bus. The communication interface is configured to perform an action in a corresponding method.

According to a sixth aspect, a communication apparatus is provided, applied to a receiving apparatus, and including a processor. The processor is configured to execute computer instructions, to implement any method provided in the second aspect, and may be the communication apparatus according to the fourth aspect.

In an embodiment, the receiving apparatus further includes a memory, the processor is coupled to the memory, and the memory is configured to store the computer instructions.

In an embodiment, the memory and the processor are integrated together, or the memory and the processor are independent components.

In an embodiment, the receiving apparatus further includes a communication interface and a communication bus, and the processor, the memory, and the communication interface are connected through the communication bus. The communication interface is configured to perform an action in a corresponding method.

According to a seventh aspect, a sending apparatus is provided, including a logic circuit and an output interface. The logic circuit and the output interface are configured to implement any method provided in the first aspect, and may be the communication apparatus according to the third aspect. The logic circuit is configured to perform a processing action in a corresponding method, and the output interface is configured to perform an action in a corresponding method.

According to an eighth aspect, a receiving apparatus is provided, including a logic circuit and an input interface. The logic circuit and the input interface are configured to implement any method provided in the second aspect, and may be the communication apparatus according to the fourth aspect. The logic circuit is configured to perform a processing action in a corresponding method, and the input interface is configured to perform an action in a corresponding method.

According to a ninth aspect, a computer-readable storage medium is provided. The computer-readable storage medium stores computer instructions, and when the computer instructions are run on a computer, the computer is enabled to perform any method provided in the first aspect, the second aspect, and the possible implementations of the first aspect and the second aspect.

According to a tenth aspect, a computer program product including computer instructions is provided. When the computer instructions are run on a computer, the computer is enabled to perform any method provided in the first aspect, the second aspect, and the possible implementations of the first aspect and the second aspect.

According to an eleventh aspect, a communication system is provided, including a sending apparatus and a receiving apparatus. The sending apparatus is configured to perform the method in any design of the first aspect and the possible implementations of the first aspect. The receiving apparatus is configured to perform the method in any design of the second aspect and the possible implementations of the second aspect.

For technical effects brought by any design in the fifth aspect to the eleventh aspect, refer to technical effects brought by corresponding designs in the first aspect to the fourth aspect. Details are not described herein again.

### BRIEF DESCRIPTION OF DRAWINGS

FIG. 1 is a schematic diagram of an architecture of a communication system according to an embodiment of this application;

FIG. 2 is a schematic diagram of an architecture of a communication system according to an embodiment of this application;

FIG. 3 is a schematic diagram of a transmission procedure of a digital solution according to an embodiment of this application;

FIG. 4 is a schematic diagram of a system architecture of a coding method according to an embodiment of this application;

FIG. 5 is a schematic diagram of probability distribution of an uncompressed source and a compressed source of a video according to an embodiment of this application;

FIG. 6 is a schematic flowchart of a coding method according to an embodiment of this application;

FIG. 7A and FIG. 7B are a schematic flowchart of a coding method according to an embodiment of this application;

FIG. 8 is a schematic diagram of a relationship between a source distribution probability and a source entropy according to an embodiment of this application;

FIG. 9 is a signaling indication process according to an embodiment of this application;

FIG. 10 is another signaling indication process according to an embodiment of this application;

FIG. 11 is another signaling indication process according to an embodiment of this application;

FIG. 12 is another signaling indication process according to an embodiment of this application;

FIG. 13 is a schematic diagram of a signaling structure of a channel coding/decoding mode indication according to an embodiment of this application;

FIG. 14 is a schematic diagram of a puncturing manner of encoded information bits according to an embodiment of this application;

FIG. 15 is a schematic diagram of another puncturing manner of encoded information bits according to an embodiment of this application;

FIG. 16 is a schematic diagram of a signaling structure of another channel coding/decoding mode indication according to an embodiment of this application;

FIG. 17 is a schematic diagram of a signaling structure of another channel coding/decoding mode indication according to an embodiment of this application;

FIG. 18 is a schematic diagram of a signaling structure of another channel coding/decoding mode indication according to an embodiment of this application;

FIG. 19 is a schematic diagram of a signaling structure of another channel coding/decoding mode indication according to an embodiment of this application;

FIG. 20 is a schematic diagram of a signaling structure of another channel coding/decoding mode indication according to an embodiment of this application;

FIG. 21 is a schematic diagram of a signaling structure of another channel coding/decoding mode indication according to an embodiment of this application;

FIG. 22 is a schematic diagram of a signaling structure of another channel coding/decoding mode indication according to an embodiment of this application;

FIG. 23 is a schematic diagram of a signaling structure of another channel coding/decoding mode indication according to an embodiment of this application;

FIG. 24 is a schematic diagram of a signaling structure of another channel coding/decoding mode indication according to an embodiment of this application;

FIG. 25 is a schematic diagram of a signaling structure of another channel coding/decoding mode indication according to an embodiment of this application;

FIG. 26 is a schematic diagram of a signaling structure of another channel coding/decoding mode indication according to an embodiment of this application;

FIG. 27 is a schematic diagram of a signaling structure of another channel coding/decoding mode indication according to an embodiment of this application;

FIG. 28 is a schematic diagram of a signaling structure of a source distribution information indication according to an embodiment of this application;

FIG. 29 is a schematic diagram of a signaling structure of another source distribution information indication according to an embodiment of this application;

FIG. 30 is a schematic diagram of a signaling structure of a joint indication of source distribution and a channel coding mode according to an embodiment of this application;

FIG. 31 is a schematic diagram of a signaling structure of another joint indication of source distribution and a channel coding mode according to an embodiment of this application;

FIG. 32 is a schematic diagram of a signaling structure of another joint indication of source distribution and a channel coding mode according to an embodiment of this application;

FIG. 33 is a schematic diagram of a signaling structure of another joint indication of source distribution and a channel coding mode according to an embodiment of this application;

FIG. 34 is a schematic diagram of a structure of a communication apparatus 100 according to an embodiment of this application;

FIG. 35 is a schematic diagram of a structure of a communication apparatus 200 according to an embodiment of this application; and

FIG. 36 is a schematic diagram of a structure of a communication apparatus 300 according to an embodiment of this application.

### DESCRIPTION OF EMBODIMENTS

The following clearly and completely describes the technical solutions in embodiments of this application with reference to the accompanying drawings in embodiments of this application.

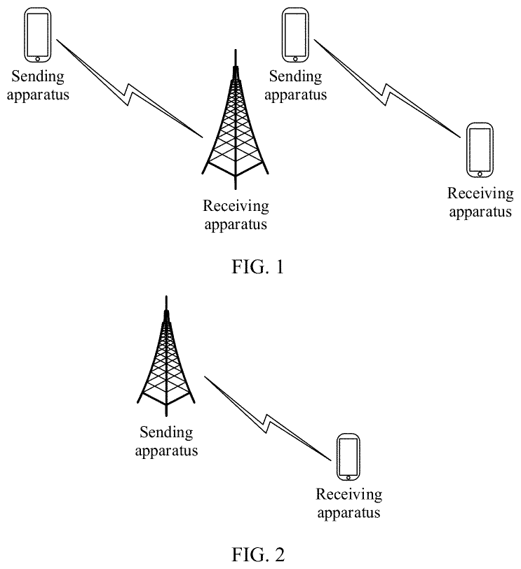

An embodiment of this application provides a communication system. The communication system includes a sending apparatus and a receiving apparatus. The sending apparatus may be a network device or a terminal. When the sending apparatus is the network device, the receiving apparatus may be the terminal. When the sending apparatus is the terminal, the receiving apparatus may be the network device or the terminal. For a schematic diagram of an architecture of the communication system, refer to FIG. 1. When the sending apparatus is the network device, and the receiving apparatus is the terminal, for a schematic diagram of an architecture of the communication system, refer to FIG. 2.

The network device may be an apparatus that is deployed in a radio access network (RAN) and that provides a wireless communication function for the terminal, for example, may be a base station, and control nodes in various forms including a network controller and a radio controller (for example, a radio controller in a cloud radio access network (CRAN) scenario). For example, the network device may be a macro base station, a micro base station (also referred to as a small cell), a relay station, an access point (AP), or the like in various forms, or may be an antenna panel of a base station. The control node may be connected to a plurality of base stations, and configure resources for a plurality of terminals within coverage of the plurality of base stations. In systems that use different radio access technologies, names of devices having functions of the base station may vary. For example, the base station may be referred to as an evolved NodeB (eNB or eNodeB) in a long term evolution (LTE) system, or may be referred to as a next generation NodeB (gNB) in a 5^{th} generation (5G) system or a new radio (NR). A specific name of the base station is not limited in this application. The network device may alternatively be a network device in a future evolved public land mobile network (PLMN) or the like.

User equipment (UE) may be a device that provides voice or data connectivity for a user, and may also be referred to as a terminal, a mobile station, a subscriber unit, a station, or terminal equipment (TE). For example, the terminal may be a cellular phone, a personal digital assistant (PDA), a wireless modem, a handheld, a laptop computer, a cordless phone, a wireless local loop (WLL), a smart TV, a tablet (pad), a smartphone, VR glasses, customer premises equipment (CPE), a sensor having a network access function, and the like. With development of wireless communication technologies, there are more and more scenarios to which the wireless communication technology may be applied and there are more and more products generated therefrom. Any device that can access a communication system, can communicate with a network side in the communication system, or can communicate with another object through the communication system may be the terminal in embodiments of this application. For example, the device may be a terminal and a vehicle in intelligent transportation, a household device in smart household, an electricity meter reading instrument in a smart grid, a voltage monitoring instrument, an environment monitoring instrument, a video surveillance instrument in an intelligent security network, or a cashing machine.

The technical solutions provided in embodiments of this application may be applied to a plurality of communication scenarios, for example, a machine to machine (M2M) scenario, a macro-micro communication scenario, an enhanced mobile broadband (eMBB) scenario, an ultra-reliable and low-latency communication (URLLC) scenario, and a massive machine-type communication (mMTC) scenario.

Network architectures and service scenarios described in embodiments of this application are intended to describe the technical solutions in embodiments of this application more clearly, and do not constitute any limitation on the technical solutions provided in embodiments of this application. A person of ordinary skill in the art may learn that the technical solutions provided in embodiments of this application are also applicable to a similar technical problem as a network architecture evolves and a new service scenario emerges.

To make this application clearer, some concepts and content mentioned in this application are first briefly described.

1. General Process of Sending and Receiving Data

In the data sending and receiving process, the sending apparatus performs source coding, channel coding, modulation, and resource mapping on a source to obtain a signal, and sends the signal to the receiving apparatus. When being transmitted on a channel between the sending apparatus and the receiving apparatus, the signal may be interfered by noise. After receiving the signal, the receiving apparatus performs resource demapping, demodulation, channel decoding, and source decoding on the signal to obtain a sink (namely, a restored source).

2. Source Coding

Source coding is a transformation performed on a source to improve communication effectiveness, or is a transformation performed on a source to reduce or eliminate source redundancy. A main index of source coding is coding efficiency. Specifically, source coding means to find a method based on a statistic feature, to transform the source into a shortest bit sequence, so that an average information amount loaded by bits of the shortest bit sequence is the largest, and an original source can be restored without distortion.

A reverse process of source coding is source decoding. Source decoding is a process of restoring a signal before source decoding to obtain the source.

3. Channel Coding

Channel coding, also referred to as error control coding, is to add a redundant bit to an information bit in the sending apparatus, and the redundant bit is related to the information bit. A signal obtained after channel coding includes the information bit and the redundant bit. A main target of channel coding is to improve reliability of information transmission.

An inverse process of channel coding is channel decoding. Channel decoding means that the receiving apparatus detects and corrects an error generated in a transmission process based on a correlation between the redundant bit and the information bit, and restores the information bit, thereby resisting interference in the transmission process and improving reliability of data transmission.

4. Modulation

Modulation means mapping bits in a bit sequence to constellation symbols in a constellation diagram. One constellation symbol includes one or more bits, and one bit in the bit sequence may be mapped to one bit in the constellation symbol.

An objective of modulation is to process a digital signal (for example, the foregoing bit sequence) that needs to be transmitted in time domain, frequency domain, or code domain, to transmit as much information as possible by using a bandwidth as small as possible.

A reverse process of modulation is demodulation. The demodulation is a process of restoring the bit sequence from the constellation symbol.

5. Resource Mapping

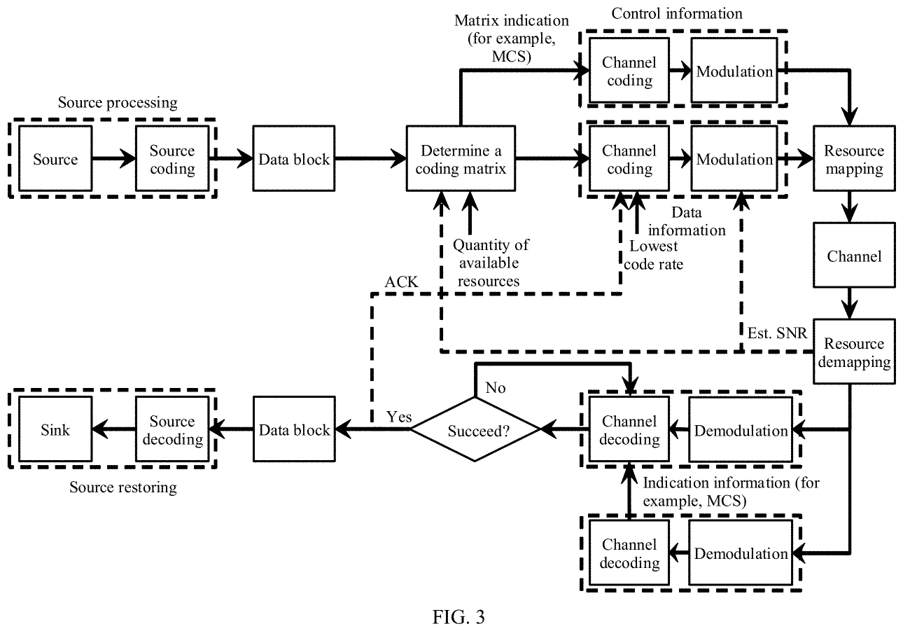

Resource mapping is a process of mapping a signal (for example, a constellation-modulated signal in FIG. 3) to a transmission resource (for example, a time-domain resource, a frequency-domain resource, or a space-domain resource).

A reverse process of resource mapping is resource demapping. Resource demapping is a process of restoring the signal mapped to the transmission resource to obtain a signal before mapping.

6. Code Rate

The code rate means a ratio of bits (namely, information bits) before encoding to bits after encoding. If one bit sequence is encoded in a coding scheme with a lower code rate, more redundant bits exist in an encoded bit sequence, and data transmission reliability is higher.

7. Code Length

The code length means a quantity of bits in an encoded bit sequence. When a quantity of information bits is fixed, if encoding is performed in a coding scheme with a longer code length, more redundant bits exist in an encoded bit sequence, and data transmission reliability is higher.

8. Modulation Order

The modulation order is used to calculate a quantity of bits that can be represented by each constellation symbol. Modulation orders corresponding to binary phase shift keying (BPSK), quadrature phase shift keying (QPSK), 8 quadrature amplitude modulation (QAM), 16 QAM, 32 QAM, 64 QAM, and 256 QAM are respectively 2, 4, 8, 16, 32, 64, and 256. Quantities of bits corresponding to these modulation orders are respectively log₂(2) (that is, 1) and log₂(4) (that is, 2), log₂(8) (that is, 3), log₂(16) (that is, 4), log₂(32) (that is, 5), log₂(64) (that is, 6), and log 2(256) (that is, 8).

A higher modulation order indicates a higher bit error rate (BER). From a perspective of the constellation diagram, a higher modulation order indicates denser constellation symbols (that is, constellation points). For example, when the modulation order is 32, a quantity of constellation symbols in the constellation diagram is 32, and when the modulation order is 64, a quantity of constellation symbols in the constellation diagram is 64. Denser constellation symbols in the constellation diagram indicate a closer distance between the constellation symbols, and one constellation symbol is more likely to be decided as another constellation symbol. Therefore, the BER is higher.

FIG. 3 is a schematic diagram of a transmission procedure of a digital solution. A digital communication system based on independent (separate) source and channel coding (SSCC) is used. FIG. 3 shows only some operations in the data sending and receiving process. In actual implementation, there may be other operations. This is not limited in this embodiment of this application.

A main procedure of the sending apparatus includes: Source processing is to input original source data, perform a source coding (compression) operation on the original source data, obtain a compressed bit stream, and divide the compressed bit stream into several data blocks. Channel processing is to determine, based on information such as channel state information fed back by the receiving apparatus (for example, an estimated signal-to-noise ratio such as Est. SNR in FIG. 3) and a quantity of available resources, a to-be-used channel coding matrix and a to-be-used modulation order; and the to-be-used channel coding matrix and the to-be-used modulation order may be indicated by using a modulation and coding scheme (MCS). Indication information such as the MCS is sent based on control information, and the control information is processed by using a preset channel coding and modulation scheme. Data blocks obtained after channel coding and modulation processing is performed on the data blocks corresponding to the compressed bit stream are sent as data information. The control information and the data information are mapped to a transmission resource block (for example, a time-domain resource or a frequency-domain resource), to complete a transmission operation.

A main procedure of the receiving apparatus includes: A parameter of the control information is first solved, and the data information is restored based on the parameter. When the data information fails to be restored, a check bit or retransmission information of the data information may continue to be received by using a retransmission mechanism, and decoding continues to be attempted. After decoding succeeds, an ACK is returned to the sending apparatus, and a next data packet is transmitted. Combining and source decoding are performed on the data blocks restored through channel decoding to obtain restored source information (namely, a sink).

In this embodiment of this application, to better perform adaptive signal transmission and reduce a delay, a data processing method based on joint source and channel coding (JSCC) is provided. Source coding and channel coding are combined, to resist channel fading when a source is compressed, thereby reducing distortion of a received signal. Moreover, the JSCC-based data processing method can limit error spread in a small range, to resolve a problem of large-scale error spread caused by bit errors in conventional entropy coding. Entropy coding is a lossless data compression scheme independent of a specific feature of a medium. A main type of entropy coding is to create and allocate a unique prefix code for each input symbol, and then replace each fixed-length input symbol with a corresponding variable-length and prefix-independent output codeword to compress data. A length of each codeword is approximately proportional to a negative logarithm of a probability. Therefore, most common symbols use shortest codes. Because different symbols correspond to different prefix codes and have different codeword lengths, when an error occurs in transmission, an error occurs in prefix code mapping, which results in a subsequent decoding error or failure, and the problem of large-scale error spread caused by the bit errors in conventional entropy coding occurs.

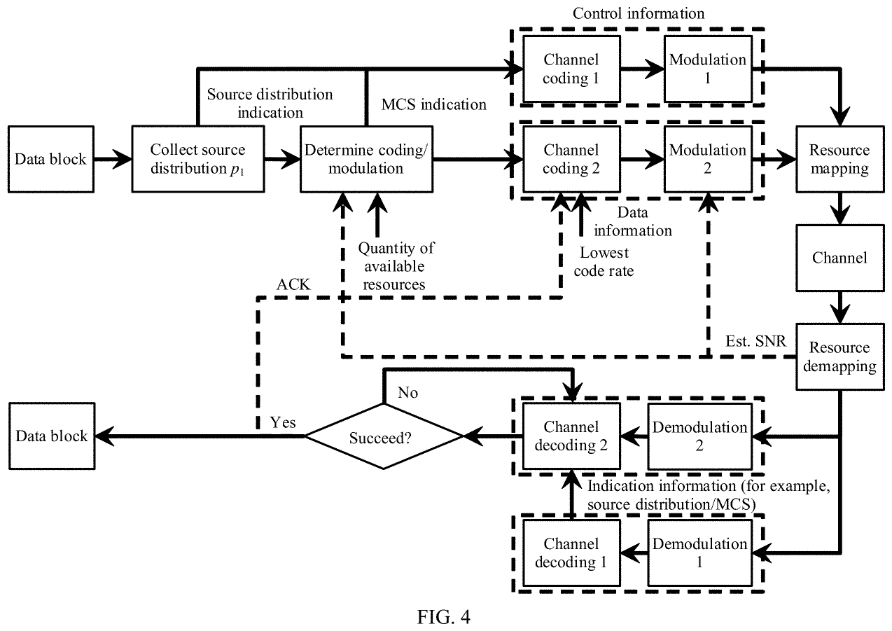

FIG. 4 is a schematic diagram of a system architecture of a JSCC-based coding method provided in an embodiment of this application. A main procedure of a transmit end is as follows: performing a block division operation on original data or data obtained after source coding to obtain a data block (to-be-encoded data), collecting source distribution, determining a coding/modulation scheme based on a quantity of available resources, performing channel coding and modulation on the to-be-encoded data, performing resource mapping on a modulated signal, and sending the signal through a channel.

A source distribution probability p₁ may be collected at a physical layer or at a MAC layer. A most basic source is a single message (symbol) source, which can be represented by a random variable x and its distribution probability p₁, and is usually written as (x, p₁). A value range of the source distribution probability p₁ is 0 to 1. The coding scheme and the modulation scheme are determined based on the collected source distribution probability p₁ or a source entropy, channel state information (for example, an estimated signal-to-noise ratio) fed back by a channel, and a quantity of currently allocated available resources. In this embodiment of this application, the source entropy is also referred to as an information entropy of the to-be-encoded data. The source entropy means a mathematical expectation of a self-information amount of each discrete message of the source, in other words, the source entropy is a statistical average weighted by the source distribution probability. A value range of the source entropy is 0 to 1. Each value except 0.5 corresponds to two complementary probability values. It can be learned that an original source distribution probability may be restored by using an indication of the source entropy. The channel state information includes but is not limited to a channel estimation signal-to-noise ratio (Est. SNR), a channel quality index, and the like. The coding scheme includes selection of a coding matrix and a channel coding mode, and the channel coding mode relates to a specific information bit puncturing policy. The source distribution (including the source distribution probability or the source entropy), the coding scheme, and the modulation scheme are transmitted to the receiving apparatus based on control information in a signaling indication manner.

Information such as the source distribution, the coding scheme, and the modulation scheme is decoded based on the received control information. The information is applied to data information for decoding. A main procedure of a receive end includes: performing resource demapping, demodulating a symbol obtained after resource demapping, and performing channel decoding on demodulated data, to obtain a data block. If decoding fails, an ACK may be sent to the transmit end, and then data retransmission is performed again.

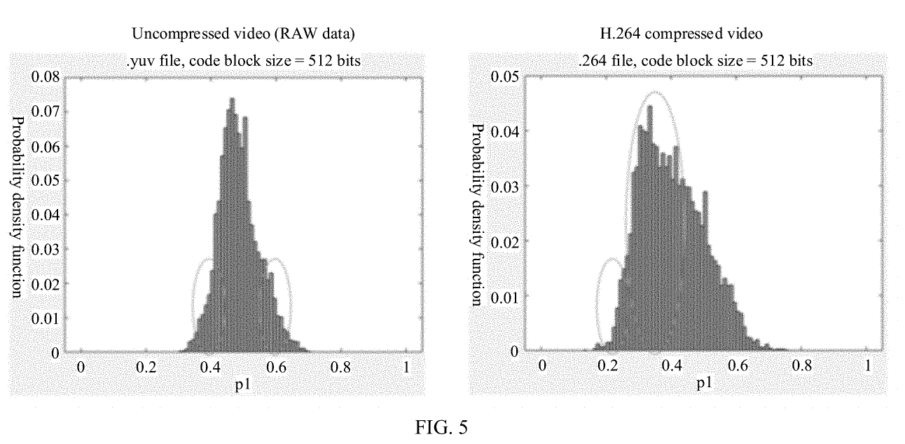

An SSCC-based coding method is designed based on the Shannon's separation theory, that is, it is assumed that bits obtained after source coding are in an equiprobable random sequence. When channel coding is designed, it is assumed that inputs are in the equiprobable random sequence, but even after source processing, obtained data blocks may still be in an unequiprobable random sequence. For example, source probability distribution of an uncompressed source and a compressed source in a video is shown in FIG. 5. A horizontal coordinate is a source probability distribution value, and a vertical coordinate is a probability density function of a source probability in each distribution value. It can be learned from the collected source distribution in FIG. 5 that, the data blocks obtained after data processing may still be in the unequiprobable random sequence, that is, source distribution of each of parts circled in the figure is far away from 0.5. Ignoring this unequiprobability in channel coding may have a negative impact on coding performance. In the JSCC-based coding method, a case in which the original data or the data obtained after source coding is in the unequiprobable random sequence is considered, source distribution information is introduced, the source distribution information is used to indicate the unequiprobable random sequence, and a channel state and the source distribution are considered during selection of the coding matrix. Moreover, the source distribution information is added to the receive end, which can significantly enhance coding/decoding performance, and achieve a specific compression effect by using source redundancy.

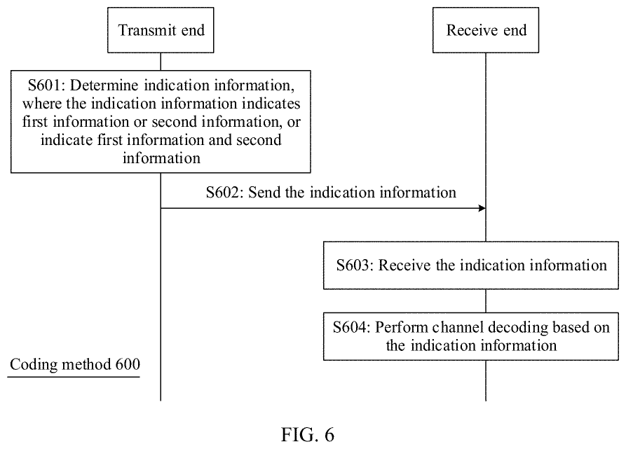

This application provides a schematic flowchart of a coding method 600. Refer to FIG. 6. The coding method 600 includes but is not limited to the following operations.

Operation S601: A sending apparatus determines indication information, where the indication information indicates first information or second information, or the indication information indicates first information and second information.

Operation S602: The sending apparatus sends the indication information.

Operation S603: The receiving apparatus receives the indication information.

Operation S604: The receiving apparatus performs channel decoding based on the indication information.

Specifically, in the coding method 600, the sending apparatus can send the indication information to the receiving apparatus, where the indication information indicates the first information or the second information, or the indication information indicates the first information and the second information.

The first information indicates a coding scheme of to-be-encoded data, and the coding scheme includes a coding matrix for channel coding and/or a channel coding mode; and the second information indicates a distribution feature of the to-be-encoded data.

The sending apparatus performs channel coding on the to-be-encoded data based on the coding scheme, to obtain encoded data.

Specifically, the indication information is carried in control information of a MAC layer. The to-be-encoded data includes original data or data obtained after source coding is performed on the original data. The coding matrix is a matrix used for encoding the to-be-encoded data. The channel coding mode indicates a puncturing manner of encoded information bits, or the channel coding mode indicates a puncturing manner of a part of the encoded information bits and a data length of the part of the encoded information bits. The channel coding mode includes three channel coding modes, which are a first channel coding mode, a second channel coding mode, and a third channel coding mode. The first channel coding mode, that is, a normal channel coding mode (a mode 1), indicates the sending apparatus not to puncture the encoded information bits; the second channel coding mode, that is, a compressed channel coding mode (a mode 2), indicates the sending apparatus to puncture all the encoded information bits; and the third channel coding mode, that is, a partial compressed channel coding mode (a mode 3), indicates the sending apparatus to puncture the part of the encoded information bits.

The second information may be a source distribution feature (or source distribution information), and indicates a distribution feature of the to-be-encoded data, and is determined based on a distribution probability of the to-be-encoded data or an information entropy of the to-be-encoded data. The channel coding mode indicated by the first information is determined based on the distribution probability of the to-be-encoded data (or the information entropy of the to-be-encoded data), channel state information, and a quantity of currently allocated available resources of a channel.

The receiving apparatus performs channel decoding on received data based on the indication information. When the indication information includes the source distribution information, a decoding process of the receiving apparatus may be referred to as performing joint source and channel decoding.

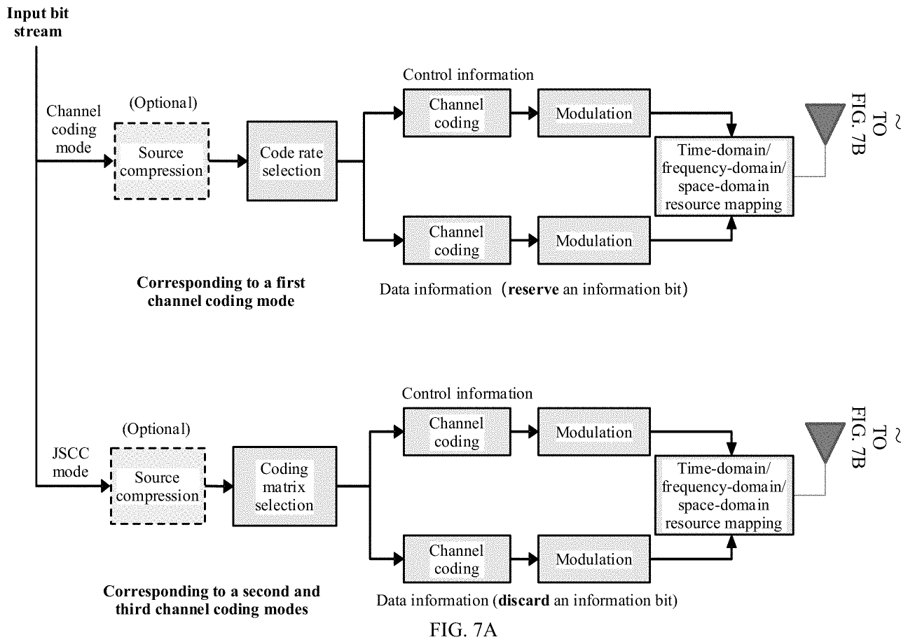

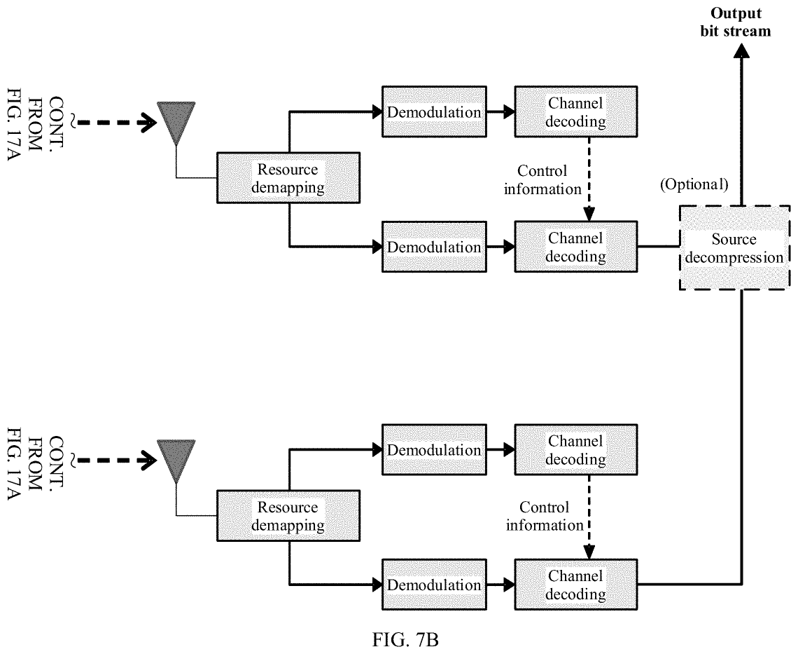

In an embodiment of this application, FIG. 7A and FIG. 7B are a schematic flowchart of a coding method. Compared with an existing system, this coding method has good compatibility, and may be flexibly switched between a conventional channel coding mode and a JSCC mode, and may be referred to as a joint source and channel coding scheme. Source coding and channel coding are combined, to resist channel fading while compressing a source, thereby reducing distortion of a received signal.

When the channel coding mode is corresponding to the foregoing first channel coding mode, source compression may be performed or not performed on an input bit stream. Then, a channel code rate is selected based on channel feedback information, and information bits are completely sent after channel coding is performed on data. A bit stream obtained after channel coding is sent out after modulation and time/frequency/space-domain resource mapping. Indication information such as an MCS and a code length is sent by using control information. The control information is processed by using a preset channel coding and modulation scheme. The control information may be transmitted in a cellular system through a physical downlink control channel/physical uplink control channel (PDCCH/PUCCH), or the like. In a Wi-Fi system, the control information can be transmitted by using an SIG. A receiving apparatus first solves a parameter of the control information part, and data information is restored based on the parameter.

When the JSCC mode is corresponding to the foregoing second channel coding mode or the foregoing third channel coding mode, source compression may be performed or not performed on an input bit stream. Then, source distribution of to-be-channel-encoded bits is collected, a proper channel coding matrix is selected, and a channel coding operation is completed. After channel coding is performed on data, a part of or all information bits are discarded based on a selected puncturing manner. A bit stream obtained after channel coding is sent out after modulation and time/frequency/space-domain resource mapping. Indication information such as the source distribution, the puncturing manner, and the MCS is sent by using control information, and the control information is processed by using a preset channel coding and modulation scheme. The control information may also be transmitted in a cellular system through a PDCCH/PUCCH, or the like, and may also be transmitted by using an SIG in a Wi-Fi system. The receiving apparatus first solves a parameter of the control information part, and data information is restored based on the parameter.

In this embodiment of this application, the channel coding mode in the coding scheme is used as an example for description. The coding matrix in the coding scheme is used to encode the to-be-encoded data (or a to-be-transmitted information bit), which may be indicated by using uplink control information (UCI), downlink control information (DCI), or the like at a physical layer. Related indication information, indication manner, and the like are similar to those of the channel coding mode, and may be obtained in a same manner.

A channel coding mode (CC mode) indication is added to a control information element (CE) of a media access control (MAC) layer, to indicate a puncturing manner or indicate a puncturing manner of a data segment and length information of the data segment. The channel coding mode includes three modes: a normal channel coding mode (a mode 1), a compressed channel coding mode (a mode 2), and a partial compressed channel coding mode (a mode 3).

When the channel coding mode is the mode 1, the sending apparatus does not perform a puncturing operation on a data block, and sends indication information, including a coding scheme and a modulation scheme that are used in this case, by using control information. The coding scheme includes a coding matrix and a channel coding mode (the mode 1), and the data block and a check bit are sent through a channel. The channel coding mode is the mode 1, higher transmission reliability can be provided when a channel state is poor. At the receiving apparatus, the coding scheme and the modulation scheme are decoded based on the received control information. When the channel coding mode is the mode 2, the sending apparatus punctures all information bits, sends indication information, including a coding scheme and a modulation scheme that are used in this case, by using control information. The coding scheme includes a coding matrix and a channel coding mode (the mode 2), and a check bit is sent through a channel. When the channel coding mode is the mode 2, a higher source compression rate is implemented when a channel state is good, thereby saving transmission resources for transmitting more source information. At the receiving apparatus, the coding scheme and the modulation scheme are decoded based on the received control information. When the channel coding mode is the mode 3, the sending apparatus punctures a part of the information bits, sends indication information, including a coding scheme and a modulation scheme that are used in this case, by using control information. The coding scheme includes a coding matrix and a channel coding mode (the mode 3), and a punctured data block and a punctured check bit are sent through a channel. When the channel coding mode is the mode 3, different channel states can be dynamically adapted to and more flexible adjustment of a source compression rate is supported. At the receiving apparatus, the coding scheme and the modulation scheme are decoded based on the received control information.

Selection of the coding matrix and the channel coding mode may be determined based on a change in the source distribution, channel state information fed back by a channel, and a quantity of currently allocated available resources. When the source distribution is even, or when a ratio of a source bit 0 or 1 is close to 0.5, the mode 1 is preferred. When the source distribution is uneven, or when a ratio of a source bit 0 or 1 is closer to 0, the source distribution is considered to be more uneven, the mode 2 or the mode 3 is selected based on unevenness of the source distribution. Because the source distribution in the data block is separately calculated, when the source distribution in the data block is different, different compression rates need to be used to compress the source. In this case, a corresponding actual code rate changes accordingly. Therefore, the part of the punctured information bits in the mode 3 can support flexible adjustment of the actual code rate. Flexible selection of the channel coding mode supports transmission of the different source distribution, and can cope with a change in the channel state and a change in the actual code rate.

A source distribution indication is added to the MAC CE, to indicate source distribution information or indicate source distribution information of a data segment and length information of the data segment. Source distribution indication information plays different roles in the three channel coding modes. When the channel coding mode is the mode 1, at the sending apparatus, when there is no source distribution indication, selection of the channel coding matrix and the code rate is affected only by the channel state. After the source distribution indication is added, selection of the channel coding matrix and the code rate is affected by the source distribution and the channel state, to achieve different transmission reliability. At the receiving apparatus, a check matrix corresponding to decoding is selected based on the channel state, and information bit soft information input by a decoder is corrected by using the source distribution information, so that a decoding bit error rate can be decreased. When the channel coding mode is the mode 2, at the sending apparatus, the source distribution also affects selection of the channel coding matrix and the code rate, to implement different compression effects. Specifically, when the source distribution is different, corresponding source entropies are different, that is, source compressible redundancy changes. Therefore, different compression rates need to be used to compress the source, and correspond to different code rates. In addition, when the channel coding matrix is designed, the source distribution may also be used as additional information, thereby improving coding/decoding performance. At the receiving apparatus, a check matrix corresponding to decoding is selected based on the source distribution and the channel state, and information bit soft information input by a decoder is corrected by using the source distribution information, so that a decoding bit error rate can be decreased.

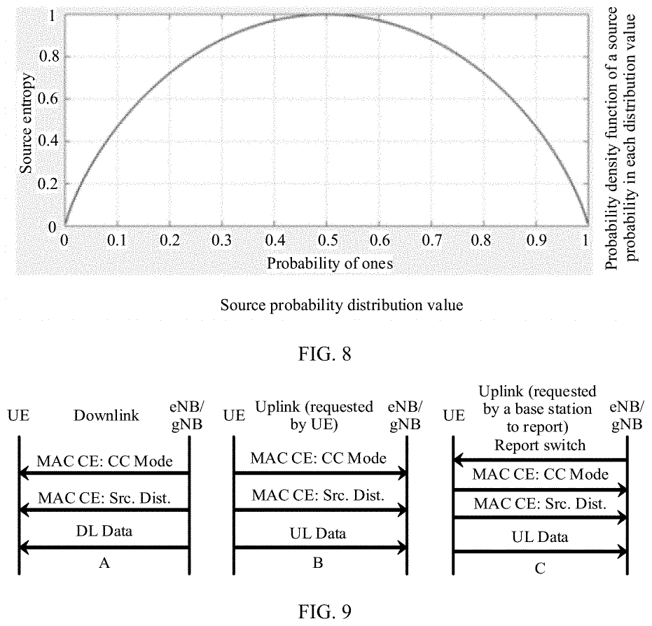

The source distribution information is several discrete intervals quantified, based on a source distribution probability p₁ or a source entropy, from different source distribution features, that is, the source distribution information. When a quantization result is obtained based on the source distribution probability p₁, it is known that a value range of the source distribution probability is 0 to 1. When a quantization bit width is B, the quantization bit width is uniformly divided into 2B parts, which may be expressed as 0, 1/(2B−1), 2/(2B−1), . . . , 1, or may be expressed as 1/2B, 2/2B, . . . , 1. When a quantization result is obtained based on the source entropy H(p₁), it is known that a value range of the source entropy is 0 to 1, and an entropy function is defined as H(p)=p×log₂(1/p)+(1−p)×log₂(1/(1−p)). Each value except 0.5 corresponds to two complementary probability values. For example, if p₁+q₁i=1, H(p₁)=H(q₁). When a quantization bit width is B, 1-bit information indicates that p₁≤0.5 or p₁>0.5. For example, when p₁≤0.5, the bit is 0, and when p₁>0.5, the bit is 1; or when p₁<0.5, the bit is 1, and when p₁>0.5, the bit is 0. Remaining (B−1)-bit information indicates values of the source entropy, that is, when p₁≤0.5, H(p₁)=1/2^{B-1}, 2/2^{B-1}, . . . , 1, and when p₁>0.5, H(p₁)=0, 1/2^{B-1}, . . . , (2B−1)/2^{B-1}. The original source distribution probability can be restored by using the source entropy indication. For example, as shown in a schematic diagram of an example of a relationship between the source distribution probability and the source entropy shown in FIG. 8, in a case of 4-bit quantization, for the source entropy, one bit indicates p₁≤0.5 or p₁>0.5, and the other three bits indicate values of the source entropy, that is, when p₁≤0.5, H(p₁)=⅛, 2/8, . . . , 1, and when p₁>0.5, H(p₁)=0, ⅛, . . . , ⅞. The 4-bit quantization of a corresponding source distribution probability is p₁=0, 1/15, 2/15, . . . , 1, or p₁= 1/16, 2/16, . . . , 1.

In addition, a non-uniform quantization manner may also be considered. The distribution probability p₁ is still used as an example. If the quantization bit width is 4, 16 quantization intervals are included in total, for example, [0, 0.01), [0.01, 0.02), [0.02, 0.04), [0.04, 0.07), [0.07, 0.11), [0.11, 0.2), [0.2, 0.3), [0.3, 0.5), [0.5, 0.7], (0.7, 0.8], (0.8, 0.89], (0.89, 0.93], (0.93, 0.96], (0.96, 0.98], (0.98, 0.99], (0.99, 1]. A quantization form is not limited in this embodiment of this application. The foregoing uniform quantization and non-uniform quantization are merely examples for description.

In this embodiment of this application, a new MAC CE logical channel identifier (LCID) is separately added to a downlink shared channel (DL-SCH) and an uplink shared channel (UL-SCH), and a new index field (Codepoint/Index) is allocated. An index field reserved in an existing standard may be used, or a new bit is subsequently added to extend a range of the index field, to carry a channel coding mode indication and a source distribution information indication. Names of the channel coding mode indication and the source distribution information indication are not limited in this embodiment of this application, and include indication information bits or other forms that can implement a same function. A specific signaling process includes an independent indication manner and a joint indication manner, and a function of the indication information may be implemented in different manners of carrying information fields. In an embodiment, the indication information indicates information in the independent indication manner, where the independent indication manner can independently indicate the channel coding mode and the source distribution information of the to-be-encoded data, and the information indication is performed by separately carrying the channel coding mode or the source distribution information of the to-be-encoded data. This implementation is more flexible. In some cases, a single piece of information may be separately reported, and the other piece of information may continue to use indication information at a previous moment or a default value agreed upon in advance by both the sender and the receiver.

In another embodiment, the indication information indicates information in the joint indication manner, and the joint indication manner can jointly indicate the channel coding mode and the source distribution information of the to-be-encoded data. The information indication is performed by carrying both the channel coding mode and the source distribution information of the to-be-encoded data in the joint indication manner. In this implementation, signaling overheads can be reduced when both the channel coding mode and the source distribution need to be indicated.

In the two indication manners, different indication forms may be used. For example, three different indication forms may be included. A first indication form is applied to downlink data transmission, and may be referred to as a downlink indication manner. A base station (the sending apparatus, for example, eNB/gNB) sends indication information to user equipment (a terminal, user/UE), for example, carrying the indication information in a MAC CE field, and then the base station performs channel coding based on the indication information, to determine a data block and a check bit that are to be sent to the user equipment and complete subsequent downlink data transmission. A second indication form is applied to uplink data transmission, and uplink user equipment UE may actively send an indication. For example, the user equipment sends, to a base station, a MAC CE field that carries indication information, and the user equipment performs channel coding based on the indication information, to determine a data block and a check bit that are to be sent to the base station and complete subsequent uplink data transmission. A third indication manner is used for uplink data transmission. An uplink base station requests user equipment to report an indication. The base station sends a report request to the user equipment. The report request indicates the user equipment to report indication information to the base station. The user equipment sends, to the base station, a MAC CE field that carries the indication information. Then, the user equipment performs channel coding based on the indication information reported by the user equipment, to determine a data block and a check bit that are to be sent and complete subsequent uplink data transmission.

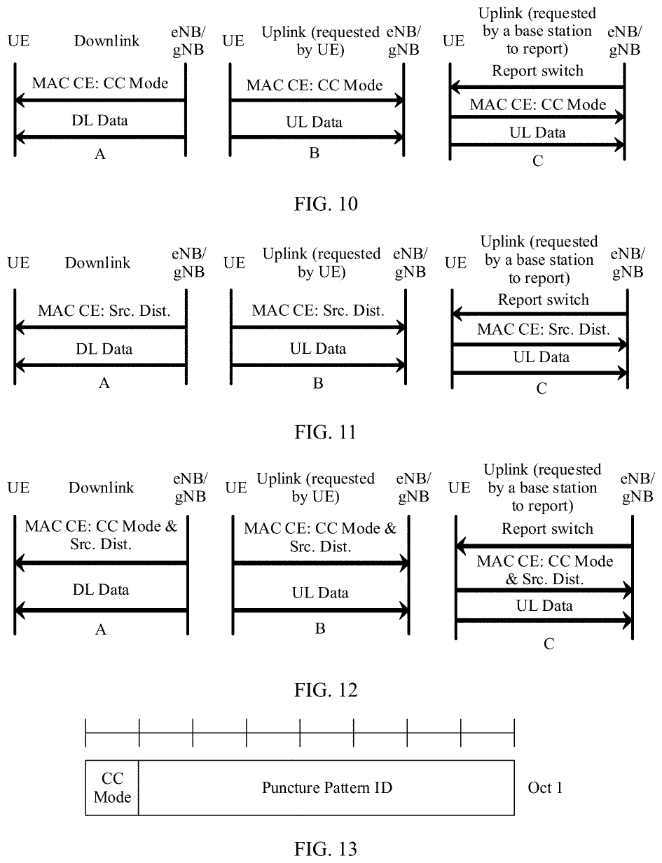

In the independent indication manner, the channel coding mode and the source distribution information of the to-be-encoded data are independently indicated as shown in FIG. 9. Three different indication forms respectively correspond to FIG. 9A, FIG. 9B, and FIG. 9C. In the independent indication manner, the carried indication information is one of the channel coding mode (CC Mode) and the source distribution information (Src.Dist.) of the to-be-encoded data. The information indication is performed by using a MAC CE field that separately carries the CC mode or the source distribution twice. The two types of indication information are sent in any sequence. In another implementation, the indication information may be sent only once, that is, a single piece of indication information is sent, and another piece of information may continue to use indication information at a previous moment or a default value agreed upon in advance by both the sender and the receiver. In this case, the single piece of information independently reported may be the CC mode or the source distribution. As shown in FIG. 10 or FIG. 11, three different indication forms respectively correspond to FIG. 10A, FIG. 10B, and FIG. 10C or FIG. 11A, FIG. 11B, and FIG. 11C.

In the joint indication manner, the channel coding mode and the source distribution information of the to-be-encoded data are jointly indicated as shown in FIG. 12. Three different indication forms respectively correspond to FIG. 12A, FIG. 12B, and FIG. 12C. In the joint indication manner, the carried indication information is the channel coding mode (CC Mode) and the source distribution information (Source Distribution) of the to-be-encoded data, and the information indication is performed by sending a MAC CE field that carries both the CC mode and the source distribution once.

In this embodiment of this application, a signaling indication manner for indicating the channel coding mode includes two indication modes: a semi-static mode and a dynamic mode.

The semi-static mode means that corresponding signaling indication information is sent to modify a current channel coding mode of data transmission, and the semi-static mode may be applied to an indication of the channel coding mode in the independent indication manner. In the semi-static mode, when the current used channel coding mode needs to be modified, MAC CE information that carries indication information of the channel coding mode CC mode is sent; otherwise, the channel coding mode remains unchanged. For example, during first data transmission, indication information sent by the sending apparatus indicates that the CC mode is the mode 1, and the receiving apparatus receives the indication information, and learns that a CC mode of the transmitted data is the mode 1. Before next indication information, indicating the CC mode, is received, the CC mode in a transmission system always uses the mode 1. When indication information sent during data transmission indicates that the CC mode is the mode 2, and the receiving apparatus receives the indication information, and learns that the CC mode changes, the CC mode in a subsequent transmission system changes to the mode 2 from this moment, and the CC mode is changed after waiting for indication information indicating that the CC mode changes next time. In the semi-static signaling indication manner, signaling overheads can be reduced without frequently switching the channel coding mode.

The dynamic mode may be applied to the independent indication manner or may be applied to the joint indication manner. The dynamic mode means that corresponding indication information is dynamically sent to indicate a channel coding mode used for a specific data part and/or source distribution information of the specific data part, where the specific data part means a data field on which the signaling indication information is applied. After the data segment is exceeded or after one dynamic mode indication ends, the data transmission automatically returns to a default state. The default state means a channel coding mode and/or source distribution information agreed by a protocol at the receive end and the transmit end. Alternatively, the default state may use a channel coding mode and indicated source distribution information that are finally used in the semi-static mode before the dynamic mode. The indication of the channel coding mode in the independent indication manner is used as an example. For example, it is assumed that when a signaling indication is sent in the semi-static mode, a channel coding mode finally used (or a default value agreed in advance by both the sender and the receiver) is the mode 1. In one dynamic indication, the indication information indicates that a CC mode of a part of transmitted data (for example, bits 0 to 2047) is the mode 2. After receiving the indication information, the receiving apparatus learns, based on the indication information, that the CC mode of the part of transmitted data (bits 0 to 2047) is the mode 2, and a CC mode used by another transmitted data bit is a mode (that is, the mode 1) finally used in the semi-static mode before the dynamic mode. In the dynamic signaling indication manner, different data segments may be separately indicated, and a more flexible channel coding mode configuration manner is provided. Names of signaling indication modes in this embodiment of this application are merely examples for description, and include indication modes that can implement a same or similar function.

The semi-static mode includes an implementation of uniformly indicating channel coding/decoding mode update of transmitted data and an implementation of performing independent indication channel coding mode change for different logical channel groups (LCG).

In an implementation, the channel coding/decoding mode update of the transmitted data is uniformly indicated. A used signaling structure is shown in FIG. 13. Oct i in the figure in embodiments of this application indicates one byte (eight bits) in the transmitted information data. When CC Mode=0 and Puncture Pattern ID=0000000, it indicates the mode 1, that is, the normal channel coding mode, where the puncture pattern ID is a puncturing pattern number, and indicates a specific puncturing manner. When CC Mode=1 and Puncture Pattern ID=0000000, it indicates the mode 2, that is, the compressed channel coding mode, and all information bits are punctured. When CC Mode=1 and Puncture Pattern ID=0000001 to 1111111, it indicates the mode 3, that is, the partial compressed channel coding mode, and a part of information bits are punctured. A 7-bit puncture pattern ID may indicate a total of 127 information bit puncturing manners. Encoded information bits may be divided into 128 segments. Each segment of information bits may be continuous or separate, and each segment includes a same quantity of bits. The encoded information bit in this embodiment of this application is also referred to as an encoded data block of each channel. The puncturing manner used in this embodiment of this application includes a continuous uniform puncturing manner, a discontinuous uniform puncturing manner, and a non-uniform puncturing manner.

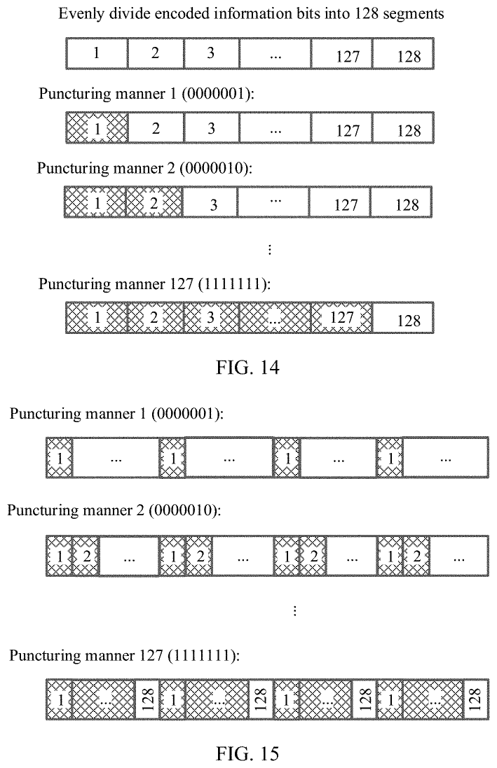

In an implementation, the encoded information bits may be divided into 128 segments in the continuous uniform puncturing manner, and each segment of information bits is continuous. As shown in FIG. 14, when Puncture Pattern ID=0000001, the first segment of information bits is punctured, when Puncture Pattern ID=0000010, the first two segments of information bits are punctured, . . . , and when Puncture Pattern ID is 1111111, the first 127 segments of information bits are punctured. In another implementation, the discontinuous uniform puncturing manner may be used, and an indication is performed in a manner in which an index corresponds to a puncturing mode.

In this implementation, information bits are divided into M segments, and lengths of the M segment of information bits obtained through division may be the same or different. Each segment of information bits is divided into 128 subsegments. When Puncture Pattern ID=0000001, the first subsegment in the 128 subsegments of each of the M segments of information bits is punctured, when Puncture Pattern ID=0000010, the first two subsegments in the 128 subsegments of each of the M segments of information bits are punctured; . . . , and when Puncture Pattern ID=1111111, the first 127 subsegments in the 128 subsegments of each of the M segments of information bits are punctured. As shown in FIG. 15, for example, the encoded information bits are divided into four segments, and lengths of the four segments of information bits may be the same or different. Then, each of the four segments of information bits is divided into 128 segments. When Puncture Pattern ID=0000001, the first segment in the 128 segments of each of the four information bits is punctured, when Puncture Pattern ID=0000010, the first two segments in the 128 segments of each of the four segments of information bits are punctured, . . . , and when Puncture Pattern ID=1111111, the first 127 segments in the 128 segments of each of the four information bits are punctured. In another implementation, the non-uniform puncturing manner may be used. In this puncturing manner, puncturing may be performed based on a random number column, or another non-uniform puncturing manner may be used. For example, there are 5000 encoded information bits in total, and a column of 5000 random numbers is obtained, and locations of encoded information bits corresponding to the first 500 digits in the random number column are punched.

In another implementation, the independent indication channel coding mode change is performed for the different logical channel groups. The LCG is a group of logical channels that are reporting buffer statuses. The logical channels are services provided by a MAC sublayer to upper layers and indicate what content is carried. The logical channels are channels that are formed for transmitting different types of information on a physical channel. The logical channels are usually classified into two categories: control channels and traffic channels. That is, the LCG represents the group of logical channels that are reporting the buffer statuses, and generally corresponds to different data services.

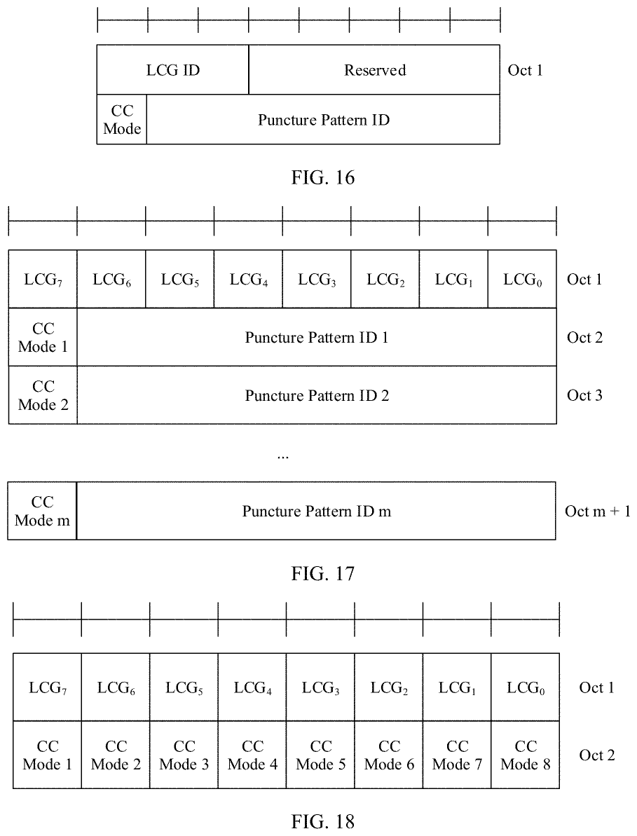

In an implementation, a single piece of LCG information needs to be indicated, and a used signaling structure is shown in FIG. 16. Meanings and indication manners of the CC mode and the puncture pattern ID are the same as those in the foregoing implementation of uniformly indicating the channel coding/decoding mode update of the transmitted data. Details are not described herein again. A difference lies in that the signaling structure includes an LCG ID indication bit, and the LCG ID indicates an LCG sequence number that needs to be indicated. A reserved bit is a reserved information bit location, and may indicate more puncturing manners, and may indicate another parameter.

In another implementation, a plurality of pieces of LCG information need to be indicated. Meanings and indication manners of the CC mode and the puncture pattern ID are the same as those in the foregoing two implementations. Details are not described herein again. The signaling structure includes an LCG ID indication bit. An LCGᵢ bit indicates whether an i^{th} LCG needs to be indicated. If the LCGᵢ is 0, it indicates that the i^{th} LCG does not need to be indicated, and if the LCGᵢ is 1, it indicates that a CC mode of the i^{th} LCG needs to be indicated. Alternatively, if the LCGᵢ is 1, it indicates that the i^{th} LCG does not need to be indicated, and if the LCGᵢ is 0, it indicates that a CC mode of the i^{th} LCG needs to be indicated.

For example, a signaling structure that may be used is shown in FIG. 17. In the signaling structure in FIG. 17, only an LCG that needs to be indicated is indicated, and m in the figure represents a total quantity of LCGs that need to be indicated. In another implementation of the signaling structure, all LCGs may be indicated. In this case, CC modes and puncture pattern IDs of LCG₇ to LCG₀ (or LCG₀ to LCG₇) may be sequentially indicated. In this implementation of the signaling structure, an LCG channel of a currently used channel coding mode needs to be changed to indicate a CC mode and a puncture pattern ID that need to be used. A CC mode and a puncture pattern ID of an LCG that does not need to be modified are carried as the current CC mode and the current puncture pattern ID or are carried as default values. In this embodiment of this application, an example in which only the LCG that needs to be indicated is indicated is used. However, all embodiments of this application also include an implementation of a signaling structure in which all the LCGs are indicated and in which a same or similar function can be implemented. However, details are not described in subsequent embodiments of this application. This is not limited in this application. When a signaling structure shown in FIG. 18 is used, in the current implementation, the mode 1 and the mode 2 in the channel coding mode may be indicated. When CC Mode=0, it indicates the mode 1, that is, the normal channel coding mode. When CC Mode=1, it indicates the mode 2, that is, the compressed channel coding mode, and all information bits are punctured.

The dynamic mode, the same as the semi-static mode in the foregoing embodiment of this application, includes an implementation of uniformly indicating channel coding/decoding mode update of transmitted data and an implementation of performing independent indication channel coding mode change for different logical channel groups. A difference lies in that the semi-static mode is applied to the indication of the channel coding mode in the independent indication manner, and the dynamic mode may be applied to the indication of the channel coding mode or the indication of the source distribution information in the independent indication manner, or may be applied to the joint indication manner. Signaling indication information for dynamically sending a response indicates a channel coding mode or source distribution information used for a specific data block (or a data segment), or indicates a channel coding mode and source distribution information used for a specific data block. The specific data part is a data field on which the signaling indication information is applied. In the dynamic signaling indication manner, different data segments may be separately indicated, and a more flexible indication manner is provided. After the data segment is exceeded or after one dynamic mode indication ends, a default state is automatically changed back. The default state means any channel coding mode or source distribution information agreed by a protocol at the receive end and transmit end, or the default state may also use a channel coding mode or source distribution information that is finally used in the semi-static mode before the dynamic mode. For example, the default mode is the normal channel coding/decoding mode (the mode 1), and the source distribution information is a discrete value quantized based on a quantization bit width when a default source probability density p₁=0.5.

Meanings and indication manners of the CC mode and the puncture pattern ID in signaling structures of different implementations in the dynamic mode are the same as those in the semi-static mode in the foregoing embodiment of this application. A difference lies in that length information of the specific data block needs to be indicated in the dynamic mode, and is named as a data block size in this embodiment of this application, a length unit of the data block size may be 128, 256, 512, 1024 bytes, or another unit negotiated in advance by the transmit end and the receive end. The length unit may be carried in a reserved field or a redefined new indication bit in the signaling structure. Certainly, the reserved field indicates a longer data block length, may indicate more puncturing manners, or may indicate another parameter.

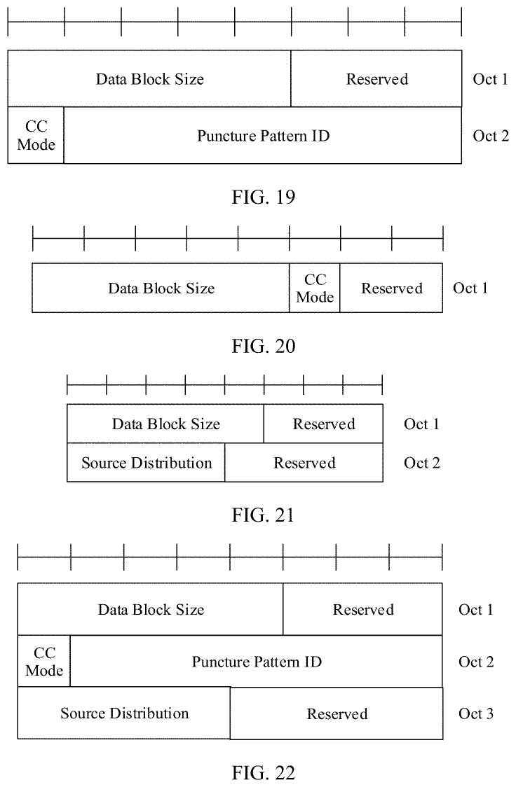

In an implementation, the channel coding/decoding mode update of the transmitted data is uniformly indicated. In an implementation, in the dynamic mode, the channel coding mode is indicated in the independent indication manner. For example, a used signaling structure is shown in FIG. 19. In the signaling structure, four bits are used to indicate a data block length. When a unit of 128 bytes is used as an example, if Data Block Size=0001 to 1111, 0001 to 1111 respectively indicate 128 bytes, 256 bytes, . . . , 1920 bytes, and 0000 indicates 2048 bytes. In FIG. 19, the data block size bit indicating the bit length and the unit length byte is used as examples. An actual signaling structure may be adjusted based on a specific situation. This is not limited in this embodiment of this application. When a signaling structure shown in FIG. 20 is used, in the current implementation, the mode 1 and the mode 2 in the channel coding mode may be indicated.

In another implementation, in the dynamic mode, the source distribution information is indicated in the independent indication manner. A signaling structure of the foregoing process is shown in FIG. 21. Source distribution indicates source distribution information of a specific data block. A reserved information bit may indicate a longer data block length or higher source distribution quantization precision, or may indicate another parameter.

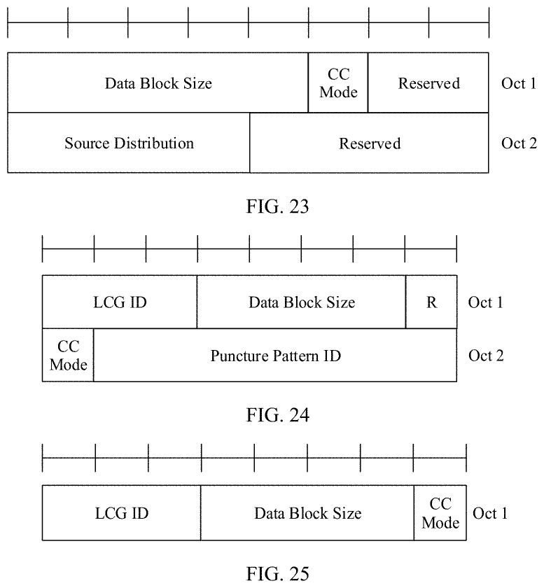

In another implementation, in the dynamic mode, the source distribution and the channel coding mode are indicated in the joint indication manner. A used signaling structure is shown in FIG. 22. A reserved information bit may indicate a longer data block length, more puncturing manners, or higher source distribution quantization precision, or may indicate another parameter. Three modes of the channel coding mode may be indicated in this signaling structure. When a signaling structure shown in FIG. 23 is used, in the current implementation, the mode 1 and the mode 2 in the channel coding mode may be indicated.

In another implementation, the implementation of performing independent indication channel coding mode change for different logical channel groups is used, and an indication manner of an LCG ID indication bit indicating LCG information in the signaling structure is the same as that in the semi-static mode of the foregoing implementation in the embodiment of this application. Details are not described herein again.

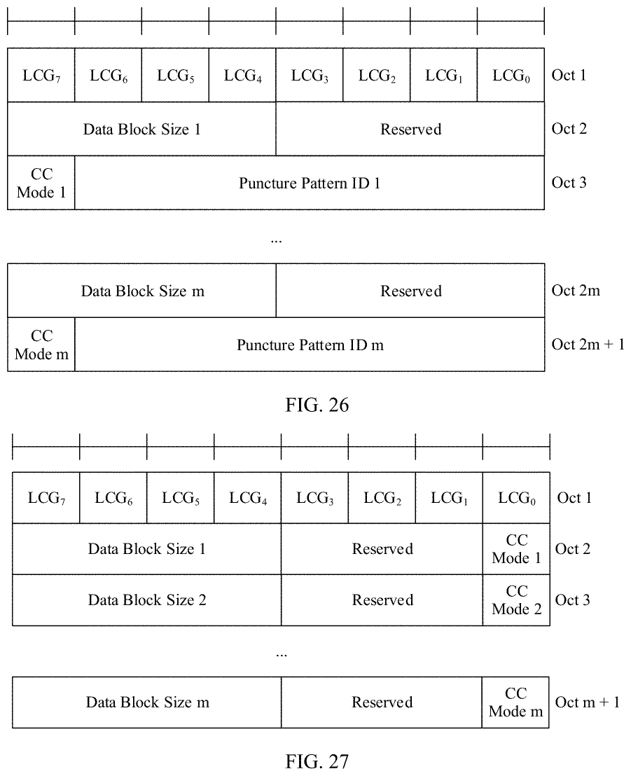

In an implementation, in the dynamic mode, a single piece of LCG information needs to be indicated in the indication of the channel coding mode in the independent indication manner. A used signaling structure is shown in FIG. 24. The signaling structure may indicate the mode 1, the mode 2, and the mode 3 in the channel coding mode. When a signaling structure shown in FIG. 25 is used, the mode 1 and the mode 2 in the channel coding mode may be indicated. In another implementation, a plurality of pieces of LCG information need to be indicated, and a used signaling structure is shown in FIG. 26. An implementation is the same as that described in the foregoing embodiment of this application. Details are not described again. A data block size i indicates a length of a specific data block of the i^{th} LCG that needs to be indicated. The signaling structure may indicate the mode 1, the mode 2, and the mode 3 in the channel coding mode. When a signaling structure shown in FIG. 27 is used, in the current implementation, the mode 1 and the mode 2 in the channel coding mode may be indicated.

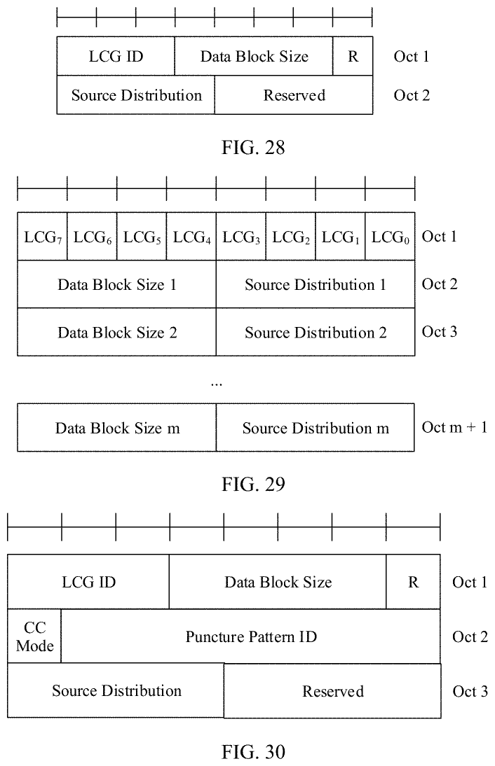

In another implementation, in the dynamic mode, in an indication of a source distribution feature in the independent indication manner, the indication of the source distribution feature is performed on the single piece of LCG information. A used signaling structure is shown in FIG. 28. A reserved information bit may indicate a length unit of a specific data block, or may indicate a longer data block length or higher source distribution quantization precision, or may indicate another parameter. In another implementation, a plurality of pieces of LCG information need to be indicated, and a used signaling structure is shown in FIG. 29. A source distribution i indicates source distribution information of a specific data block of the i^{th} LCG that needs to be transmitted. An LCGᵢ bit and an indication manner of the LCGᵢ bit are the same as those in the foregoing embodiment of the application provided that the indicated information may be replaced with the source distribution. Details are not described herein again.

In the dynamic mode, the source distribution and the channel coding mode are jointly indicated. An implementation of fields with a same name is the same as that described in the foregoing embodiment of this application. Details are not described again. In an implementation, joint indication of the source distribution and the channel coding mode may be performed on the single piece of LCG information, and a used signaling structure is shown in FIG. 30. In FIG. 30, R represents a reserved bit, and the reserved bit may indicate a longer data block length, or may indicate another parameter. Both the reserved bit and R are reserved information bits, and may indicate a longer data block length, more puncturing manners, or higher source distribution quantization precision, or may indicate another parameter. Locations of indication information of the reserved bit and R are not limited. In the current implementation, any one of the three modes of the channel coding mode may be indicated.

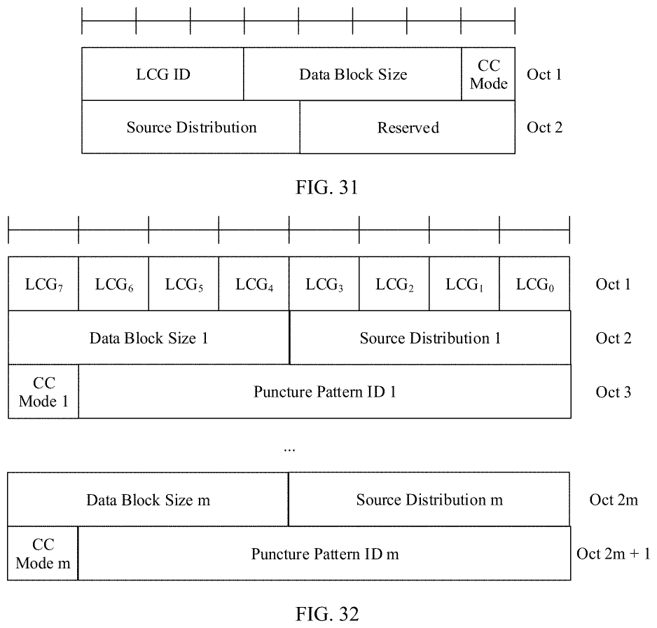

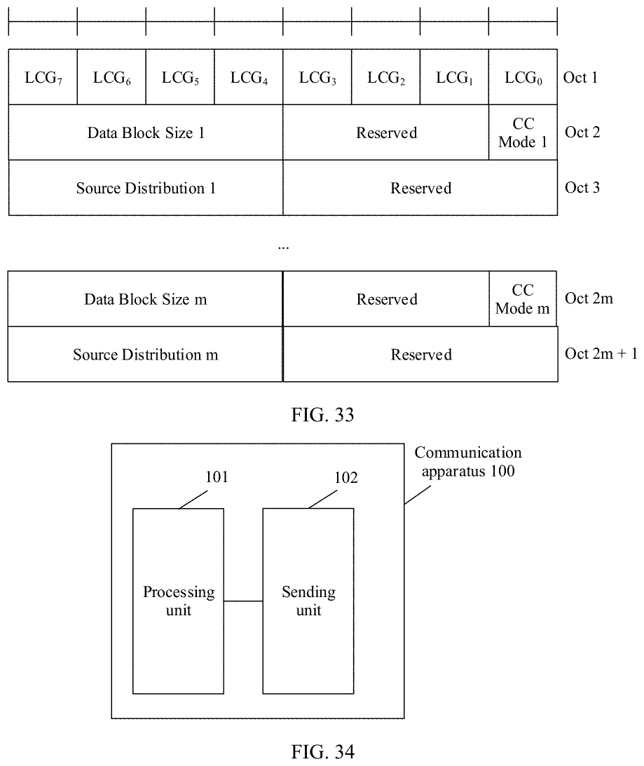

When a signaling structure shown in FIG. 31 is used, in the current implementation, the mode 1 and the mode 2 in the channel coding mode may be indicated. In another implementation, a plurality of pieces of LCG information may be indicated, and a used signaling structure is shown in FIG. 32. An LCGᵢ bit indicates whether the i^{th} LCG needs to be indicated, and a data block size i indicates a length of a specific data block of the i^{th} LCG that needs to be indicated. A source distribution i indicates source distribution information of a specific data block of the i^{th} LCG. A CC mode i indicates a channel coding mode of the i^{th} LCG that needs to be indicated. A puncture pattern ID i indicates a puncturing manner of a specific data block of the i^{th} LCG. A specific indication manner is the same as that described in the foregoing embodiment of this application. Details are not described again. In the current implementation, any one of the three modes of the channel coding mode may be indicated. When a signaling structure shown in FIG. 33 is used, in the current implementation, the mode 1 and the mode 2 in the channel coding mode may be indicated.

In this embodiment of this application, the reserved bit or field is a reserved information bit, and may indicate a longer data block length, more puncturing manners, or higher source distribution quantization precision, or may indicate another parameter. A location of indication information of the reserved bit or field is not limited. The signaling structures in embodiments of this application are all examples, and include all signaling structures that can implement a same function. This is not limited in this application.

In embodiments of this application, the signaling indication manner usually uses the dynamic mode. If two manners can be supported, that is, in the independent indication manner, the channel coding mode may use the semi-static mode, and the source distribution feature may use the dynamic mode. Therefore, one bit needs to be added to indicate whether the signaling indication manner used for the channel coding mode is the semi-static mode or the dynamic mode. The indication information bit may be located in the reserved bit or field in the signaling structure, or may be located on another indication bit defined to indicate that function. In the semi-static signaling indication manner, signaling overheads can be reduced without frequently switching the channel coding mode. In the dynamic signaling indication manner, different data segments may be separately indicated, and a more flexible channel coding mode configuration manner is provided.

In the foregoing embodiment provided in this application, the methods provided in embodiments of this application are described from the perspectives of the sending apparatus and the receiving apparatus. To implement functions in the methods provided in embodiments of this application, the sending apparatus and the receiving apparatus each may include a hardware structure and a software module, and implement the functions in a form of the hardware structure, the software module, or a combination of the hardware structure and the software module. One of the foregoing functions may be performed by using the hardware structure, the software module, or the combination of the hardware structure and the software module. The following describes communication apparatuses in embodiments of this application with reference to FIG. 34 to FIG. 36. The communication apparatus is a sending apparatus or a receiving apparatus, the communication apparatus may be an apparatus in a sending apparatus, or the communication apparatus is an apparatus in a receiving apparatus. In addition, the apparatus may be a coding apparatus of the sending apparatus and a decoding apparatus applied to the receiving apparatus. It should be understood that the coding apparatus applied to the sending apparatus is the source device in the foregoing method, and has any function of the sending apparatus in the foregoing method. The decoding apparatus applied to the receiving apparatus is the destination device in the foregoing method, and has any function of the receiving apparatus in the foregoing method. The communication apparatus may alternatively be a chip system.

A communication apparatus 100 shown in FIG. 34 may include a processing unit 101 and a sending unit 102. The processing unit 101 is configured to process data, and the sending unit 102 is configured to send data.

The communication apparatus shown in FIG. 34 is configured to perform the sending apparatus in the method embodiment described in FIG. 6.

The processing unit 101 is configured to determine indication information, where the indication information indicates first information and second information.

The sending unit 102 is configured to send the indication information.

Specifically, the sending apparatus performs joint source and channel coding based on the indication information. The first information indicates a coding scheme of to-be-encoded data, and the coding scheme includes a coding matrix for channel coding and a channel coding mode. The to-be-encoded data includes original data or data obtained after source coding is performed on the original data. The second information indicates a distribution feature of the to-be-encoded data.

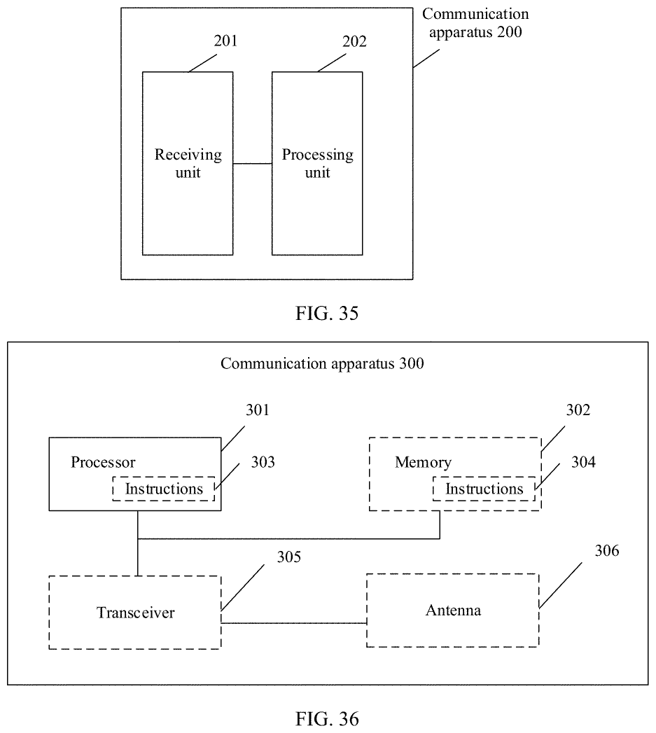

A communication apparatus 200 shown in FIG. 35 may include a receiving unit 201 and a processing unit 202. The receiving unit 201 is configured to receive data, and the processing unit 202 is configured to process data.

The communication apparatus shown in FIG. 35 is configured to perform the receiving apparatus in the method embodiment described in FIG. 6.

The receiving unit 201 is configured to receive indication information.

The processing unit 202 is configured to process indication information, where the indication information indicates first information and second information.

Specifically, the receiving apparatus performs joint source and channel decoding based on the indication information. The first information indicates a coding scheme of to-be-encoded data, and the coding scheme includes a coding matrix for channel coding and a channel coding mode. The to-be-encoded data includes original data or data obtained after source coding is performed on the original data. The second information indicates a distribution feature of the to-be-encoded data.

The communication apparatus 100 and the communication apparatus 200 have any function of the sending apparatus and the receiving apparatus in the foregoing method. For related content of the first information and the second information, refer to the foregoing embodiment. Details are not described herein again.

FIG. 36 is a schematic block diagram of another communication apparatus 300. In an implementation, the communication apparatus 300 corresponds to the foregoing sending apparatus applicable to the coding method 600. In an embodiment, the communication apparatus 300 may be the sending apparatus in FIG. 1 or an apparatus in the sending apparatus in FIG. 1. In an embodiment, the communication apparatus 300 is a chip, a chip system, a processor, or the like that implements the foregoing method embodiments. The communication apparatus 300 may be configured to implement the methods described in the foregoing method embodiments. For details, refer to the description in the foregoing method embodiments.

In another implementation, the communication apparatus 300 corresponds to the foregoing receiving apparatus applicable to the coding method 600. In an embodiment, the communication apparatus 300 may be the receiving apparatus in FIG. 1 or an apparatus in the receiving apparatus in FIG. 1. In an embodiment, the communication apparatus 300 is a chip, a chip system, a processor, or the like that implements the foregoing method embodiments. The communication apparatus 300 may be configured to implement the methods described in the foregoing method embodiments. For details, refer to the description in the foregoing method embodiments.

The communication apparatus 300 may include one or more processors 301. The processor 301 may be a general-purpose processor, a dedicated processor, or the like. For example, the processor 301 may be a baseband processor or a central processing unit. The baseband processor may be configured to process a communication protocol and communication data, and the central processing unit may be configured to control a communication apparatus (for example, a base station, a baseband chip, a terminal, a terminal chip, a DU, or a CU) to execute a computer program, to process data of the computer program.

The communication apparatus 300 may further include a transceiver 305. The transceiver 305 may be referred to as a transceiver unit, a transceiver machine, a transceiver circuit, or the like, and is configured to implement a transceiver function. The transceiver 305 may include a receiver and a transmitter. The receiver may be referred to as a receiver circuit, or the like, and is configured to implement a receiving function. The transmitter may be referred to as a transmitter circuit, or the like, and is configured to implement a sending function. The sending unit in FIG. 34 may be implemented by using a transmitter, and the receiving unit in FIG. 35 may be implemented by using a receiver. In an embodiment, the communication apparatus 300 may further include an antenna 306.

In an embodiment, the communication apparatus 300 may include one or more memories 302, and the memory 302 may store instructions 304. The instructions 304 may be a computer program. The computer program may be run on the communication apparatus 300, to enable the communication apparatus 300 to perform the methods described in the foregoing method embodiments. In an embodiment, the memory 302 may further store data. The communication apparatus 300 and the memory 302 may be separately disposed, or may be integrated.

The communication apparatus 300 is configured to implement a function of the sending apparatus in the coding method 600 in the foregoing method embodiment.

The processor 301 may be configured to execute the computer program or the program instructions 304 stored in the memory 302, so that the communication apparatus 300 implements a function of the sending apparatus in the coding method 600 in the foregoing method embodiment.

The transceiver 305 is configured to perform operations S602 and S603 in FIG. 6.

The processor 301 is configured to perform operations S601 and S604 in FIG. 6.

The communication apparatus 300 is configured to implement a function of the receiving apparatus in the coding method 600 in the foregoing method embodiment.

The processor 301 may be configured to execute the computer program or the program instructions 304 stored in the memory 302, so that the communication apparatus 300 implements a function of the receiving apparatus in the coding method 600 in the foregoing method embodiment.

The processor 301 is configured to perform operations S601 and S604 in FIG. 6.

The transceiver 305 is configured to perform operations S602 and S603 in FIG. 6.

In an implementation, the processor 301 may include a transceiver configured to implement a receiving function and a sending function. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In an implementation, the processor 301 may store instructions 303. The instructions may be a computer program. The computer program 303 is run on the processor 301, to enable the communication apparatus 300 to perform the methods described in the foregoing method embodiments. The computer program 303 may be fixed in the processor 301, and in this case, the processor 301 may be implemented by hardware.

In an implementation, the communication apparatus 300 may include a circuit, and the circuit may implement a sending, receiving, or communication function in the foregoing method embodiments. The processor and the transceiver that are described in this application may be implemented on an integrated circuit (IC), an analog IC, a radio frequency integrated circuit RFIC, a mixed-signal IC, an application-specific integrated circuit (ASIC), a printed circuit board (PCB), an electronic device, or the like. The processor and the transceiver may alternatively be manufactured by using various IC technologies, for example, a complementary metal oxide semiconductor (CMOS), an N-type metal oxide semiconductor (NMOS), a P-type metal oxide semiconductor (PMOS), a bipolar junction transistor (BJT), a bipolar CMOS (BiCMOS), silicon germanium (SiGe), and gallium arsenide (GaAs).

In an implementation, a communication system is provided, including a sending apparatus and a receiving apparatus, as shown in FIG. 1 or FIG. 2. In another possible design, the system may further include another device that interacts with the sending device and the receiving device in the solutions provided in this application. Functions and system composition implemented by the sending apparatus and the receiving apparatus are consistent with those described in embodiments of the foregoing application. Details are not described herein again.

The communication apparatus in the foregoing embodiment description may be the sending apparatus or an apparatus in the sending apparatus or the receiving apparatus or an apparatus in the receiving apparatus. However, a scope of the communication apparatus described in this application is not limited thereto. In addition, a structure of the communication apparatus may not be limited by FIG. 36. The communication apparatus may be an independent device or may be a part of a large device. For example, the communication apparatus may be:
(1) an independent integrated circuit IC, a chip, or a chip system or subsystem;
(2) a set including one or more ICs, where in an embodiment, the set of ICs may further include a storage component configured to store data and a computer program;
(3) an ASIC such as a modem;
(4) a module that can be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) others.

A person skilled in the art may further understand that various illustrative logical blocks (illustrative logic block) and operations (operation) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the scope of embodiments of this application.

This application further provides a computer-readable storage medium storing a computer program. When the computer-readable storage medium is executed by a computer, the function in any one of the foregoing method embodiments is implemented.

This application further provides a computer program product. When the computer program product is executed by a computer, functions of any one of the foregoing method embodiments are implemented.

All or some of the foregoing embodiments may be implemented by using software, hardware, firmware, or any combination thereof. When software is used to implement embodiments, all or a part of embodiments may be implemented in a form of a computer program product. The computer program product includes one or more computer programs. When the computer program is loaded and executed on a computer, the procedures or functions according to embodiments of this application are all or partially generated. The computer may be a general-purpose computer, a dedicated computer, a computer network, or other programmable apparatuses. The computer program may be stored in a computer-readable storage medium or may be transmitted from a computer-readable storage medium to another computer-readable storage medium. For example, the computer program may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

A person of ordinary skill in the art may understand that various numbers such as “first” and “second” in this application are merely used for differentiation for ease of description, and are not used to limit the scope of embodiments of this application or represent a sequence.

“The at least one” in this application may alternatively be described as one or more, and “the multiple” means two, three, four, or more. This is not limited in this application. In embodiments of this application, “first”, “second”, “third”, “A”, “B”, “C”, “D”, and the like are used for distinguishing between technical features described by them. There is no chronological order or no size order between the technical features described by “first”, “second”, “third”, “A”, “B”, “C”, and “D”.

The correspondences shown in the tables in this application may be configured, or may be predefined. Values of the information in the tables are merely examples, and other values may be configured. This is not limited in this application. When a correspondence between the information and the parameters is configured, not all the correspondences shown in the tables need to be configured. For example, in the tables in this application, correspondences shown in some rows may alternatively not be configured. For another example, proper deformations and adjustments such as splitting and combination may be performed based on the foregoing tables. Names of the parameters shown in titles of the foregoing tables may alternatively be other names that can be understood by a communication apparatus, and values or representation manners of the parameters may alternatively be other values or representation manners that can be understood by the communication apparatus. During implementation of the foregoing tables, another data structure, such as an array, a queue, a container, a stack, a linear table, a pointer, a linked list, a tree, a graph, a structure, a class, a pile, or a hash table, may alternatively be used.

“Predefine” in this application may be understood as “define”, “predefine”, “store”, “pre-store”, “pre-negotiate”, “pre-configure”, “solidify”, or “pre-burn”.

A person of ordinary skill in the art may be aware that, in combination with the examples described in embodiments disclosed in this specification, units and algorithm operations may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A decoding method, comprising:
receiving indication information, wherein the indication information indicates first information and second information, the first information indicates a channel coding mode of to-be-encoded data, and the second information indicates a distribution feature of the to-be-encoded data; and
performing channel decoding on received data based on the indication information, to obtain decoded data.

2. The method according to claim 1, wherein the indication information is carried in control information of a MAC layer.

3. The method according to claim 1, wherein the to-be-encoded data comprises original data or data obtained after source coding is performed on the original data.

4. The method according to claim 1, wherein the channel coding mode indicates a puncturing manner of encoded information bits, or the channel coding mode indicates a puncturing manner of a part of the encoded information bits and a data length of the part of the encoded information bits.

5. The method according to claim 4, wherein the channel coding mode comprises:
a first channel coding mode, a second channel coding mode, and a third channel coding mode, wherein
the first channel coding mode indicates a sending apparatus not to puncture the encoded information bits;
the second channel coding mode indicates the sending apparatus to puncture all the encoded information bits; and
the third channel coding mode indicates the sending apparatus to puncture the part of the encoded information bits.

6. The method according to claim 1, wherein the second information is determined based on a distribution probability of the to-be-encoded data or an information entropy of the to-be-encoded data.

7. The method according to claim 1, wherein the channel coding mode is determined based on the following information:
a distribution probability of the to-be-encoded data or an information entropy of the to-be-encoded data, channel state information, and a quantity of currently allocated available resources of a channel.

8. A communication apparatus, comprising:
a receiving unit, configured to receive indication information, wherein the indication information indicates first information and second information, the first information indicates a channel coding mode of to-be-encoded data, and the second information indicates a distribution feature of the to-be-encoded data; and
a processing unit, configured to perform channel decoding on received data based on the indication information, to obtain decoded data.

9. The communication apparatus according to claim 8, wherein the indication information is carried in control information of a MAC layer.

10. The communication apparatus according to claim 8, wherein the to-be-encoded data comprises original data or data obtained after source coding is performed on the original data.

11. The communication apparatus according to claim 8, wherein the channel coding mode indicates a puncturing manner of encoded information bits, or the channel coding mode indicates a puncturing manner of a part of the encoded information bits and a data length of the part of the encoded information bits.

12. The communication apparatus according to claim 11, wherein the channel coding mode comprises:
a first channel coding mode, a second channel coding mode, and a third channel coding mode, wherein
the first channel coding mode indicates a sending apparatus not to puncture the encoded information bits;
the second channel coding mode indicates the sending apparatus to puncture all the encoded information bits; and
the third channel coding mode indicates the sending apparatus to puncture the part of the encoded information bits.

13. The communication apparatus according to claim 8, wherein the second information is determined based on a distribution probability of the to-be-encoded data or an information entropy of the to-be-encoded data.

14. The communication apparatus according to claim 8, wherein the channel coding mode indicated by the first information is determined based on the following information:
a distribution probability of the to-be-encoded data or an information entropy of the to-be-encoded data, channel state information, and a quantity of currently allocated available resources of a channel.

15. A non-transitory computer-readable storage medium, wherein the computer-readable storage medium stores instructions, and when the instructions are executed by one or more processors, the one or more processor are caused to perform operations:
receiving indication information, wherein the indication information indicates first information and second information, the first information indicates a channel coding mode of to-be-encoded data, and the second information indicates a distribution feature of the to-be-encoded data; and
performing channel decoding on received data based on the indication information, to obtain decoded data.

16. The computer-readable storage medium according to claim 15, wherein the indication information is carried in control information of a MAC layer.

17. The computer-readable storage medium according to claim 15, wherein the to-be-encoded data comprises original data or data obtained after source coding is performed on the original data.

18. The computer-readable storage medium according to claim 15, wherein the channel coding mode indicates a puncturing manner of encoded information bits, or the channel coding mode indicates a puncturing manner of a part of the encoded information bits and a data length of the part of the encoded information bits.

19. The computer-readable storage medium according to claim 18, wherein the channel coding mode comprises:
a first channel coding mode, a second channel coding mode, and a third channel coding mode, wherein
the first channel coding mode indicates a sending apparatus not to puncture the encoded information bits;
the second channel coding mode indicates the sending apparatus to puncture all the encoded information bits; and
the third channel coding mode indicates the sending apparatus to puncture the part of the encoded information bits.

20. The computer-readable storage medium according to claim 15, wherein the second information is determined based on a distribution probability of the to-be-encoded data or an information entropy of the to-be-encoded data.
